(19) United States
(12) Patent Application Publication
(10) Pub. No.: US 2010/0149661 A1
(43) Pub. Date: Jun. 17, 2010

(54) Lens having a circumferential field of view

(75) Inventors: Ehud Gal, Reut (IL); Gil Graisman, Reut (IL); Ofer Pintel, Matan (IL)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignees: O.D.F. Medical Ltd., Tel Aviv (IL); O.D.F. Optronics Ltd., Tel Aviv (IL)

(21) Appl. No.: 10/586,632

(22) PCT Filed: Jan. 20, 2005
(86) PCT No.: PCT/IL05/00069

§ 371 Date: Jan. 22, 2009

(30) Foreign Application Priority Data
Jan. 21, 2004 (IL) 159977

(51) Int. Cl. G02B 13/06; G02B 17/00

(52) U.S. Cl. 359/725; 359/726

(57) ABSTRACT

A lens having an axis of symmetry, including a transparent circumferential surface, circumferentially extending about the axis of symmetry, the transparent surface having optical power in planes which include the axis of symmetry, a first reflective surface, symmetric with respect to the axis of symmetry and being operative to reflect light passing through the transparent surface and a second reflective surface, symmetric with respect to the axis of symmetry and axially spaced from the transparent surface and being operative to reflect light reflected by the first reflective surface.

### SUMMARY OF THE INVENTION

The present invention seeks to provide improved lenses and optical system having an extremely wide field of view.

There is thus provided in accordance with a preferred embodiment of the present invention a lens having an axis of symmetry, including a transparent circumferential surface, circumferentially extending about the axis of symmetry, the transparent surface having optical power in planes which include the axis of symmetry, a first reflective surface, symmetric with respect to the axis of symmetry and being operative to reflect light passing through the transparent surface and a second reflective surface, symmetric with respect to the axis of symmetry and axially spaced from the transparent surface and being operative to reflect light reflected by the first reflective surface.

Preferably, the lens is formed of at least one of glass and plastic. Additionally or alternatively, the transparent circumferential surface receives light from a 360-degree field of view about the axis of symmetry.

Preferably, the first transparent circumferential surface is transparent to radiation at a specific range of wavelengths. Additionally or alternatively, the transparent circumferential surface is operative to refract light onto the first reflective surface.

Preferably, the lens also includes an additional circumferential surface disposed between the transparent circumferential surface and the second reflective surface. Additionally, the transparent circumferential surface has a first curvature and the additional circumferential surface has a second curvature, the second curvature being generally different than the first curvature.

Preferably, the additional circumferential surface is operative to enhance an axial field of view of the lens. Additionally or alternatively, the additional circumferential surface smoothly joins the transparent circumferential surface.

Preferably, at least one of the first and second reflective surfaces is a convex reflective surface. Alternatively, each of the first and second reflective surfaces is a convex reflective surface. Preferably, the second reflective surface directs light generally along the axis of symmetry.

Preferably, at least one of the first and second reflective surfaces is annular. Alternatively, each of the first and second reflective surfaces is annular.

Preferably, the second reflective surface also includes a curved portion which has a transparent surface and which is symmetric with respect to the axis of symmetry, operative to refract rays from a field of view which is at least partially different than the 360-degree field of view. Additionally, the curved portion has a curvature which is different than a curvature of the second reflective surface. Additionally or alternatively, the transparent surface of the curved portion is transparent to radiation at a specific range of wavelengths.

Preferably, the first reflective surface also includes a central area which has a transparent surface and which is symmetric with respect to the axis of symmetry. Additionally, the central area has a curvature which is different than a curvature of the first reflective surface. Additionally or alternatively, the transparent surface of the central area is transparent to radiation at a specific range of wavelengths.

Preferably, the specific range of wavelengths includes visible wavelengths. Alternatively or additionally, the specific range of wavelengths includes infrared wavelengths.

Preferably, the lens also includes at least one additional lens arranged to direct light axially through the lens. Additionally, the lens also includes a shield element operative to protect the at least one additional lens. Preferably, a field of view of the at least one additional lens at least partially overlaps a field of view of the lens, providing stereoscopic viewing of at least one object lying in the overlapped portions of the field of view of the at least one additional lens and the field of view of the lens.

Preferably, the lens also includes at least one aberration correcting lens arranged to correct aberrations of light passing through the lens.

Preferably, the lens also includes at least one of a first base portion and a second base portion. Additionally, the first base portion is disposed about the first reflective surface. Alternatively or additionally, the second base portion is disposed about the second reflective surface.

Preferably, at least one of the first base portion and the second base portion is integrally formed with the lens. Alternatively, at least one of the first base portion and the second base portion is mounted onto the lens.

Preferably, at least one of the first base portion and the second base portion is operative to mount the lens onto additional optical elements forming an optical system. Alternatively or additionally, at least one of the first base portion and the second base portion is operative to mount the lens onto at least one mechanical element.

Preferably, light passing through the lens is directed onto an imaging element. Additionally, the imaging element includes a CCD array.

Preferably, the lens also includes a non-axially symmetric reflecting surface having optical power for focusing light from a region limited in azimuth and elevation through the lens. Additionally, the non-axially symmetric reflecting surface includes a convex surface. Alternatively, the non-axially symmetric reflecting surface includes a generally planar surface. Preferably, the additional circumferential surface is operative to refract light received by the lens onto the non-axially symmetric reflecting surface.

Preferably, the lens is operative to enable illumination of a field of view from a source of light located in an image plane.

Preferably, the lens also includes at least one light pipe, operative to illuminate the field of view of the lens. Additionally, the light pipe includes at least one inclined edge surface. Preferably, the light pipe includes optical fibers. Alternatively or additionally, the light pipe includes a hollow light pipe.

Preferably, the light pipe is disposed about the first reflective surface. Preferably, the at least one inclined edge surface is operative to scatter light rays emitted from the light pipe.

### BRIEF DESCRIPTION OF THE DRAWINGS

The present invention will be understood and appreciated more fully from the following detailed description, taken in conjunction with the drawings in which:

FIGS. 1A, 1B and 1C are, respectively, simplified rearward facing and forward facing pictorial illustrations and a sectional illustration of a circumferential field of view lens constructed and operative in accordance with a preferred embodiment of the present invention, FIG. 1C being taken along section lines IC-IC in FIG. 1A;

FIGS. 2A and 2B and 2C are, respectively, simplified rearward facing and forward facing exploded pictorial illustrations and a sectional exploded view illustration of an optical system employing the lens of FIG. 1 in accordance with a preferred embodiment of the present invention, FIG. 2C being taken along section lines IIC-IIC in FIG. 2A;

FIGS. 3A and 3B which are respectively, a simplified assembled view illustration and a sectional assembled view illustration of the optical system of FIGS. 2A-2C, FIG. 3B being taken along section lines IIIB-IIIB in FIG. 3A;

FIG. 4 is a simplified sectional illustration of a variation of the optical system of FIG. 2A-3B, employing the lens of FIG. 1 in accordance with a preferred embodiment of the present invention;

FIGS. 5A, 5B and 5C are, respectively, simplified rearward facing and forward facing pictorial illustrations and a sectional illustration of a circumferential field of view lens constructed and operative in accordance with another preferred embodiment of the present invention, FIG. 5C being taken along section lines VC-VC in FIG. 5A;

FIGS. 6A and 6B are, respectively, a simplified pictorial illustration and a sectional illustration of a circumferential field of view lens constructed and operative in accordance with yet another preferred embodiment of the present invention, FIG. 6B being taken along section lines VIB-VIB in FIG. 6A;

FIGS. 7A and 7B are, respectively, a simplified pictorial illustration and a sectional illustration of an optical system constructed and operative in accordance with another preferred embodiment of the present invention, FIG. 7B being taken along section lines VIIB-VIIB in FIG. 7A; and

FIG. 8 is a simplified illustration of an optical system constructed and operative in accordance with still another preferred embodiment of the present invention.

### DETAILED DESCRIPTION OF PREFERRED EMBODIMENTS

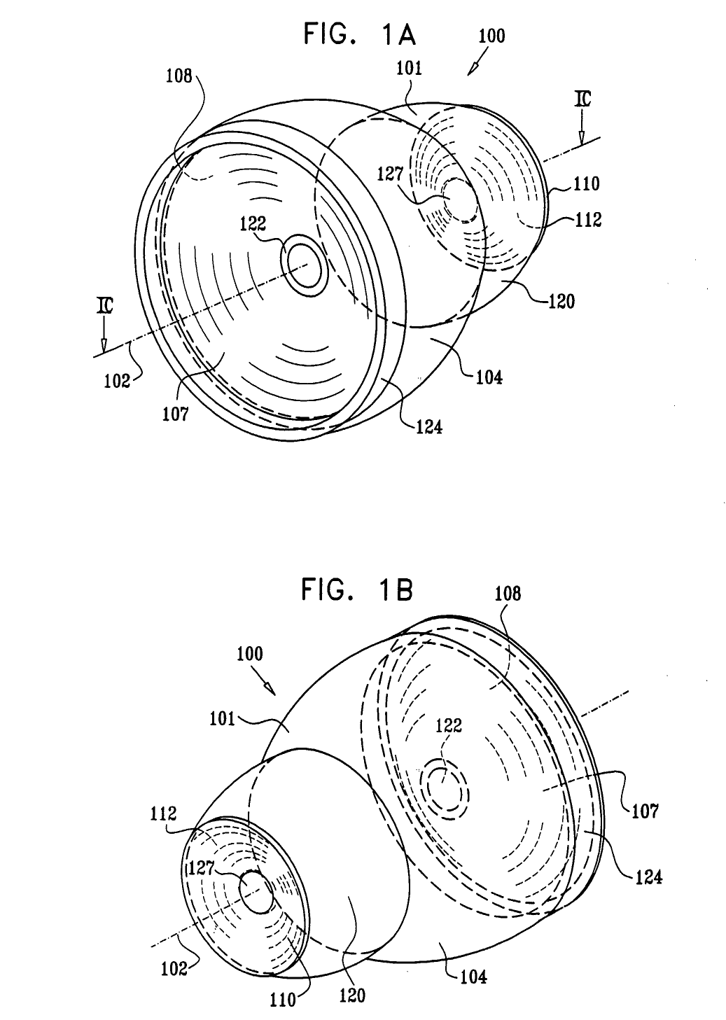

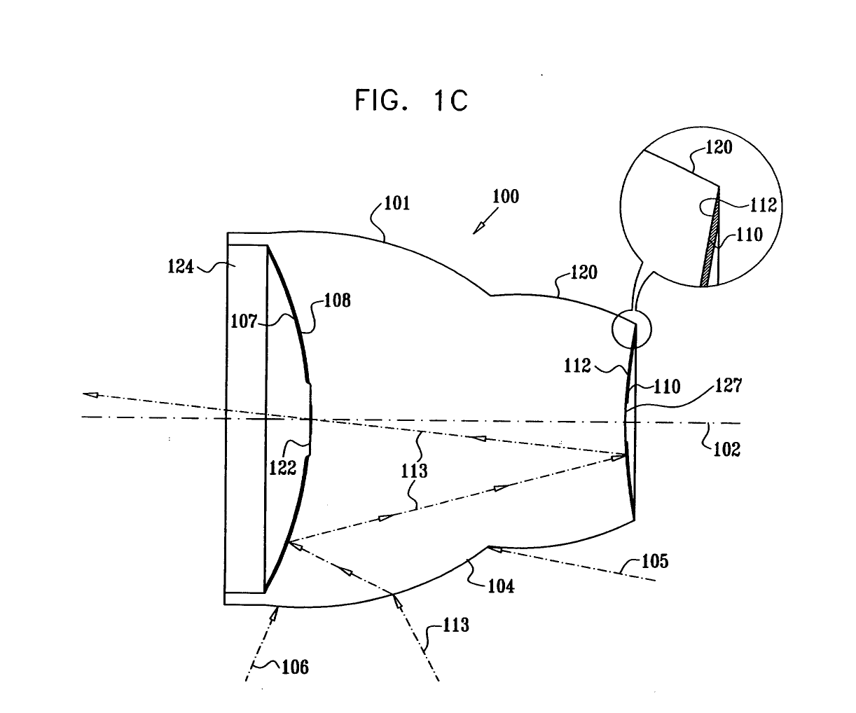

Reference is now made to FIGS. 1A, 1B and 1C, which are, respectively, simplified rearward facing and forward facing pictorial illustrations and a sectional illustration of a circumferential field of view lens constructed and operative in accordance with a preferred embodiment of the present invention. As seen in FIGS. 1A-1C, there is provided a lens 100 including a lens body 101, preferably formed of plastic, glass or any other suitable material which is transparent to radiation at a wavelength range of interest, which is symmetric about an axis of rotation 102.

Preferably the lens 100 includes a curved circumferential surface 104, having optical power, which receives light from a 360 degree field of view about axis 102, limited by rays 105 and 106, which are seen with particular clarity in FIG. 1C. Surface 104 refracts the light, as shown, onto an adjacent, preferably convex, annular reflective coating 107 formed onto a correspondingly shaped surface 108 of lens body 101. The light is reflected from convex reflective coating 107 onto an oppositely facing, preferably convex, reflective coating 110 formed onto a correspondingly shaped surface 112 of lens body 101, as shown by ray 113, which is seen with particular clarity in FIG. 1C.

It is a particular feature of the present invention that surface 112 and reflective coating 110 are substantially spaced along axis 102 from annular reflective coating 107 formed on surface 108, and thus from curved circumferential surface 104. In the illustrated embodiment, this spacing, which enhances the axial field of view of the lens defined by rays 105 and 106, is provided by configuring the lens body 101 to define an intermediate circumferential surface 120, which is preferably curved, intermediate curved circumferential surface 104 and surface 112. Intermediate circumferential surface 120 typically has a different curvature than the curvature of surface 104, and need not collect light from the field of view of interest.

Light reflected from convex reflective coating 110 preferably passes out of the lens 100 through a central portion 122 of surface 108 which is transparent to radiation at the wavelength range of interest and which is not coated by reflective coating 107.

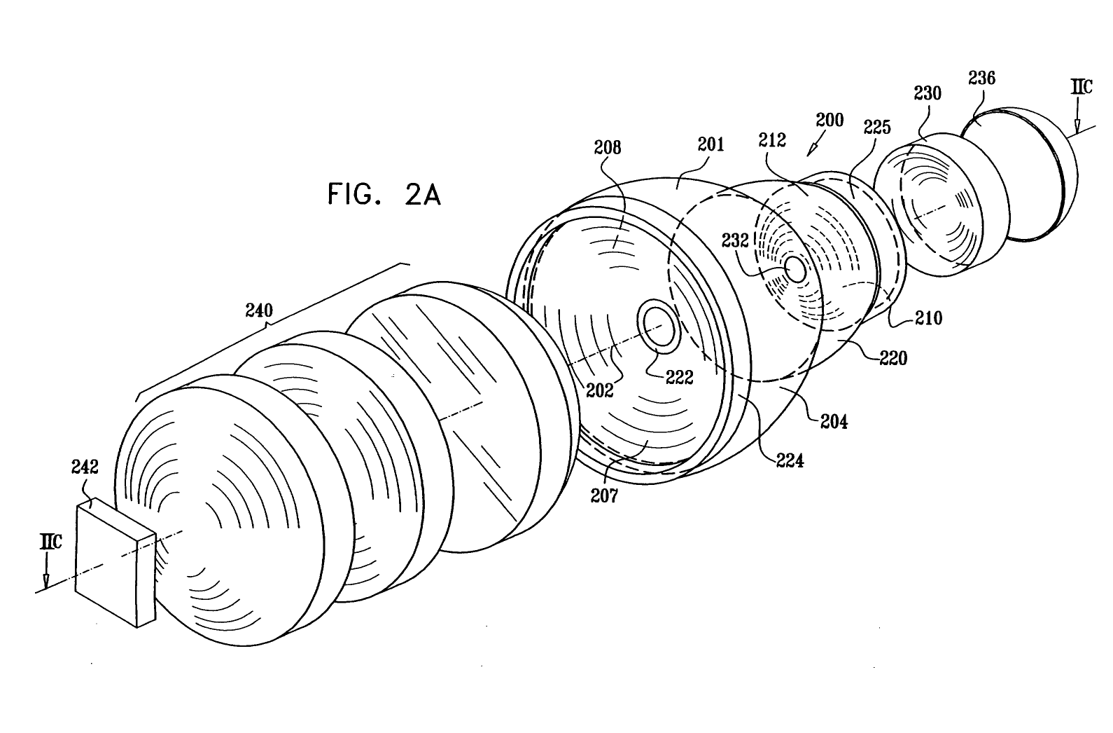

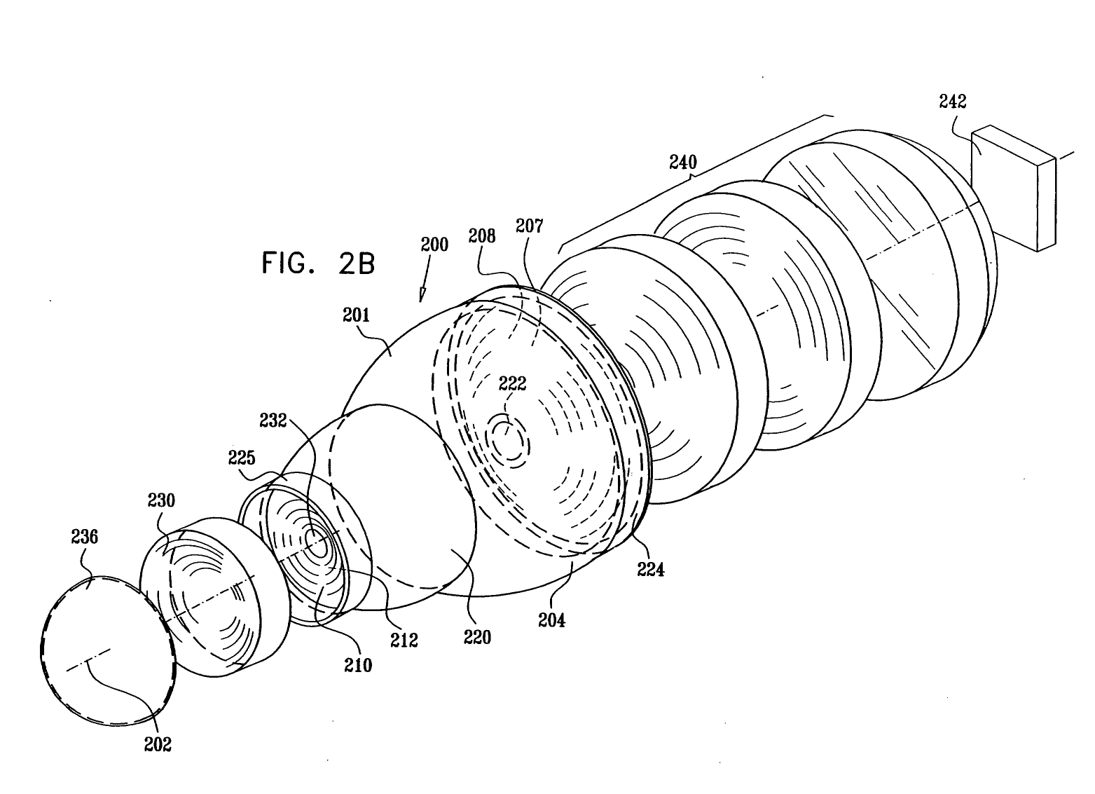

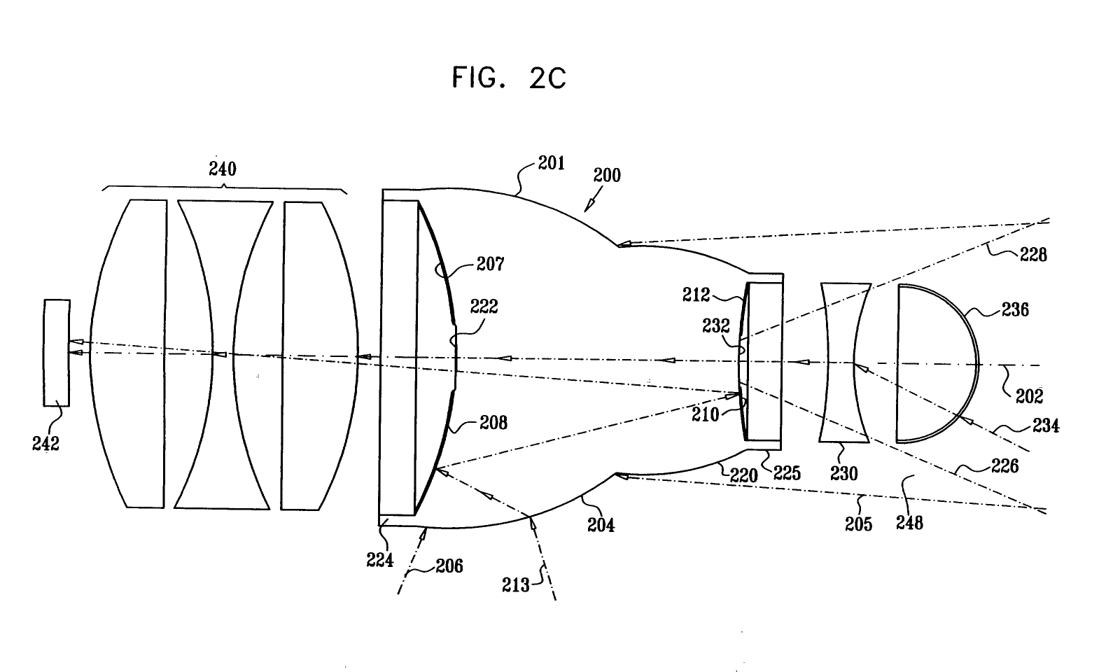

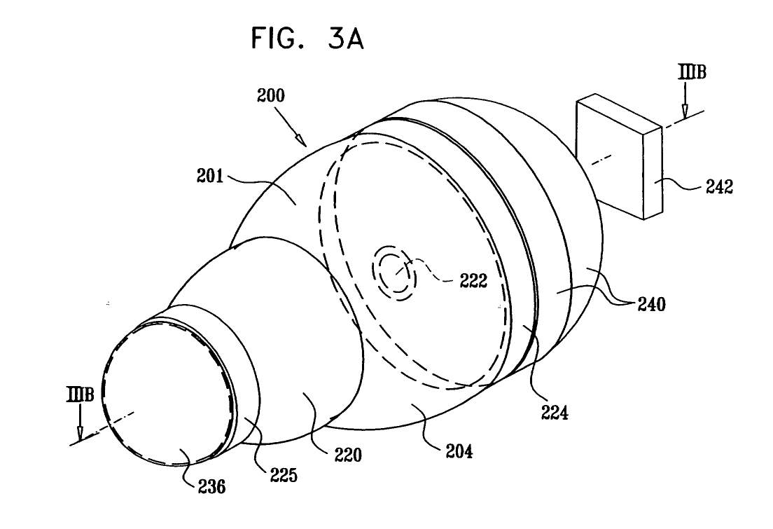

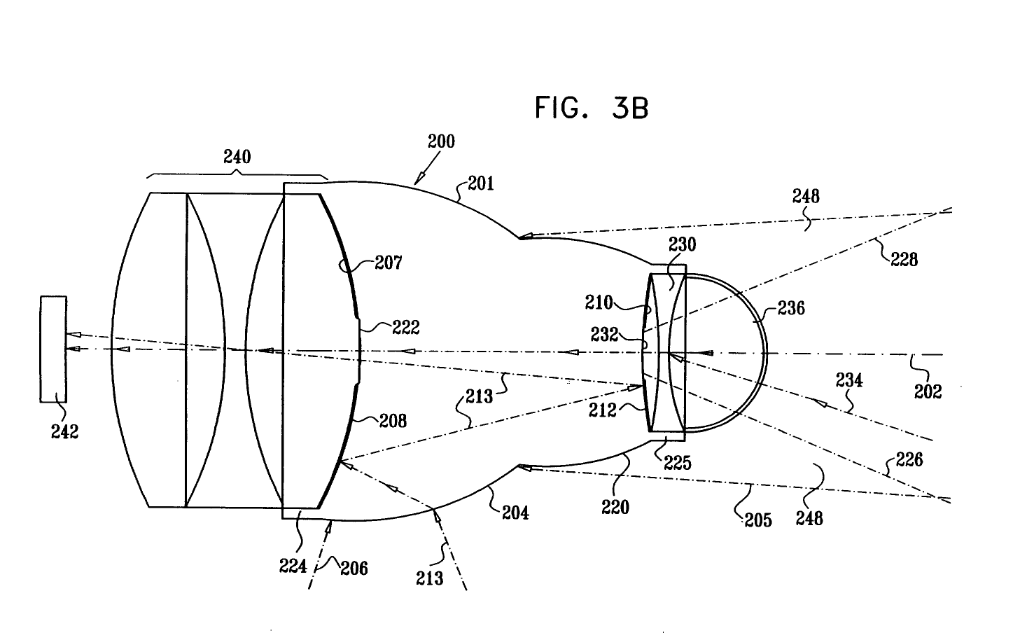

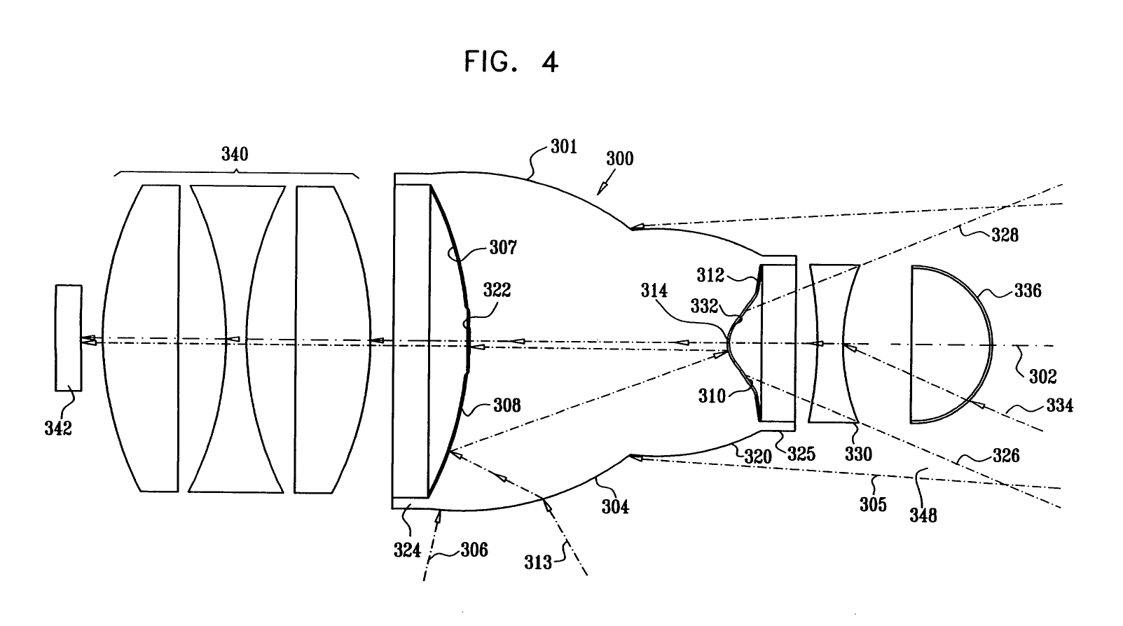

Optionally, a rear base portion 124 is provided around surface 108, to enable mounting of the lens 100 onto additional elements of an optical system, such as additional lenses, or other suitable mechanical elements, as described hereinbelow with reference to FIGS. 2 and 3. Rear base portion 124 may be integrally formed with the remainder of lens 100 or may be mounted onto the lens by any suitable means. Alternatively or additionally, a forward base portion (not shown) may be provided around surface 112 for a similar purpose.

It will be appreciated that rays of light could enter the lens 100 through central portion 122, which is transparent to radiation at a wavelength range of interest, be reflected by reflective coating 110 and pass out of the lens through central portion 122. This can be avoided if reflective coating 110 is formed with a central annular aperture, such that a central transparent portion 127 is formed on surface 112. Central transparent portion 127 enables rays of light from a forward field of view of the lens 100 to enter the lens 100 and pass through lens body 101 and central portion 122. Alternatively, lens body 101 may be formed with a bore extending therethrough (not shown), which enables passage of light rays from the center of surface 112 to the center of surface 108. It is appreciated that provision of transparent portion 127 or the bore extending through lens body 101 eliminates the reflection of light rays entering lens 100 at central portion 122.

It is appreciated that in certain cases, depending on the materials used for forming the lens body 101, total internal reflection of certain light rays may occur, thus obviating the need for some or all of the reflective coatings.

Reference is now made to FIGS. 2A, 2B and 2C, which are, respectively, simplified rearward facing and forward facing pictorial exploded view illustrations and a sectional exploded view illustration of an optical system employing the lens of FIG. 1 in accordance with a preferred embodiment of the present invention, and to FIGS. 3A and 3B, which are, respectively, a simplified assembled view illustration and a sectional assembled view illustration of the optical system of FIGS. 2A-2C. As seen in FIGS. 2A-3B, there is provided a lens 200 including a lens body 201, preferably formed of glass or any other suitable material which is transparent to radiation at a wavelength range of interest, which is symmetric about an axis of rotation 202.

Preferably the lens 200 includes a curved circumferential surface 204, having optical power, which receives light from a 360 degree field of view about axis 202. Lens 200 preferably provides a circumferential field of view of at least approximately 90 degrees, as indicated by rays 205 and 206, which are seen with particular clarity in FIG. 2C. Surface 204 refracts the light, as shown, onto an adjacent, preferably convex, annular reflective coating 207 formed onto a correspondingly shaped surface 208 of lens body 201. The light is reflected from convex reflective coating 207 onto an oppositely facing, preferably convex, reflective coating 210 formed onto a correspondingly shaped surface 212 of lens body 201, as shown by ray 213, which is seen with particular clarity in FIG. 2C.

It is a particular feature of the present invention that surface 212 and reflective coating 210 are substantially spaced along axis 202 from annular reflective coating 207 formed on surface 208, and thus from curved circumferential surface 204. In the illustrated embodiment, this spacing, which enhances the axial field of view of the lens 200 defined by rays 205 and 206, is provided by configuring the lens body 201 to define an intermediate circumferential surface 220, which is preferably curved, intermediate curved circumferential surface 204 and surface 212. Intermediate circumferential surface 220 typically has a different curvature than the curvature of surface 204, and need not collect light from the field of view of interest.

Light reflected from convex reflective coating 210 preferably passes out of the lens 200 through a central portion 222 of surface 208 which is transparent to radiation at the wavelength range of interest and which is not coated by reflective coating 207.

Lens 200 is preferably formed with a rear base portion 224 and a forward base portion 225, which are provided around surfaces 208 and 212 respectively, and which enable mounting of lens 200 onto additional elements of the optical system or other suitable mechanical elements, as described hereinbelow. Rear base portion 224 and forward base portion 225 may be integrally formed with the remainder of lens 200 or may be mounted onto the lens 200 by any suitable means.

Light from a forward field of view, limited by rays 226 and 228, preferably is refracted by a lens 230 towards a central portion 232 of surface 212, interiorly of annular reflective coating 210, through the lens body 201 and out through central portion 222 of surface 208, interiorly of annular reflective coating 207, as shown by ray 234, which is seen with particular clarity in FIG. 2C.

Preferably, lens 230 is protected by a forward facing generally hemi-spherical shield 236 which is transparent to radiation at a wavelength range of interest, which ensures that the lens 230 will not be damaged, but does not corrupt the optical path of rays in the forward field of view. Alternatively, shield 236 may be obviated, leaving lens 230 exposed. Typically, lens 230 and shield 236 are mounted onto lens 200 at forward base portion 225, as seen in FIGS. 3A and 3B.

One or more lenses 240, which may include focusing lenses and optical correction lenses operative to correct for aberrations such as astigmatism, may lie along an optical path of the light leaving the lens body 201 via central portion 222 and may direct the light onto an imaging sensor 242, such as a CCD array or any other suitable imaging sensor. Typically, lenses 240 and imaging sensor 242 are mounted onto lens 200 at rear base 224, as seen in FIGS. 3A and 3B. The complete field of view which may be imaged by imaging sensor 242 forms a hemisphere.

It is appreciated that in certain cases, depending on the materials used for forming the lens body 201, total internal reflection of certain light rays may occur, thus obviating the need for some or all of the reflective coatings.

It will be appreciated that the optical system of FIGS. 2A-3B includes a “dead space”, designated by reference numeral 248, which is not imaged by imaging sensor 242, as seen in FIG. 2C.

Reference is now made to FIG. 4, which is a simplified sectional illustration of a variation of the optical system of FIG. 2, employing the lens of FIG. 1 in accordance with yet another preferred embodiment of the present invention. FIG. 4 illustrates a structure including a lens which is similar to lens 200 (FIGS. 2A-3B), that at least partially eliminates the “dead space” 248 (FIG. 2C), by providing an annular recess located in part of the central portion 232 (FIG. 2C), preferably centered about the axis 202 (FIG. 2C).

Accordingly, there is provided in the embodiment of FIG. 4, a lens 300 including a lens body 301, preferably formed of glass or any other suitable material which is transparent to radiation at the wavelength range of interest, which is symmetric about an axis of rotation 302.

Preferably the lens 300 includes a curved circumferential surface 304, having optical power, which receives light from a 360-degree field of view about axis 302. Lens 300 preferably provides a circumferential field of view of at least approximately 90 degrees, as indicated by rays 305 and 306. Surface 304 refracts the light, as shown, onto an adjacent, preferably convex, annular reflective coating 307 formed onto a correspondingly shaped surface 308 of lens body 301. The light is reflected from convex reflective coating 307 onto an oppositely facing, preferably convex, reflective coating 310 formed onto a correspondingly shaped surface 312 of lens body 301, as shown by ray 313. Convex surface 312 preferably includes a curved portion 314 having a different curvature than the curvature of surface 312. Curved portion 314 is not coated by reflective coating 310 and enables the provision of a wider forward field of view relative to the field of view shown in FIG. 2C by rays 226 and 228.

It is a particular feature of the present invention that surface 312, including curved portion 314, and reflective coating 310 are substantially spaced along axis 302 from annular reflective coating 307 formed on surface 308, and thus from curved circumferential surface 304. In the illustrated embodiment, this spacing, which enhances the axial field of view of the lens 300 defined by rays 305 and 306, is provided by configuring the lens body 301 to define an intermediate circumferential surface 320, which is preferably curved, intermediate curved circumferential surface 304 and surface 312. Intermediate circumferential surface 320 typically has a different curvature than the curvature of surface 304, and need not collect light from the field of view of interest.

Light reflected from convex reflective coating 310 preferably passes out of the lens 300 through a central portion 322 of surface 308 which is transparent to radiation at a wavelength range of interest and which is not coated by reflective coating 307.

Lens 300 is preferably formed with a rear base portion 324 and a forward base portion 325, which are provided around surfaces 308 and 312 respectively, and which enable mounting of lens 300 onto additional elements of the optical system or other suitable mechanical elements, as described hereinbelow. Rear base portion 324 and forward base portion 325 may be integrally formed with the remainder of lens 300 or may be mounted onto the lens 300 by any suitable means.

Light from a forward field of view, limited by rays 326 and 328, preferably is refracted by a lens 330 through curved portion 314 and/or through a central portion 332 of surface 312, interiorly of annular reflective coating 310, through the lens body 301 and out through central portion 322 of surface 308, interiorly of annular reflective coating 307, as shown by ray 334.

Preferably, lens 330 is protected by a forward facing generally hemi-spherical shield 336 which is transparent to radiation at a wavelength range of interest and which ensures that the lens 330 will not be damaged, but does not corrupt the optical path of rays in the forward field of view. Alternatively, shield 336 may be obviated, leaving lens 330 exposed. Typically, lens 330 and shield 336 are mounted onto lens 300 at forward base portion 325.

One or more lenses 340, which may include focusing lenses and optical correction lenses operative to correct for aberrations such as astigmatism, may lie along an optical path of the light leaving the lens body 301 via central portion 322 and may direct the light onto an imaging sensor 342, such as a CCD array or any other suitable imaging sensor. Typically, lenses 340 and imaging sensor 342 are mounted onto lens 300 at rear base 324. The complete field of view which may be imaged by imaging sensor 342 forms a hemisphere.

It is appreciated that in certain cases, depending on the materials used for forming the lens body 301, total internal reflection of certain light rays may occur, thus obviating the need for some or all of the reflective coatings.

It is further appreciated that the optical system of FIG. 4 includes a “dead space”, designated by reference numeral 348, which is not imaged by imaging sensor 342. As described hereinabove, curved portion 314 enables the provision of a wider forward field of view than the field of view shown in FIG. 2C by rays 226 and 228, thus dead space 348 is smaller than dead space 248 shown in FIGS. 2C and 3B.

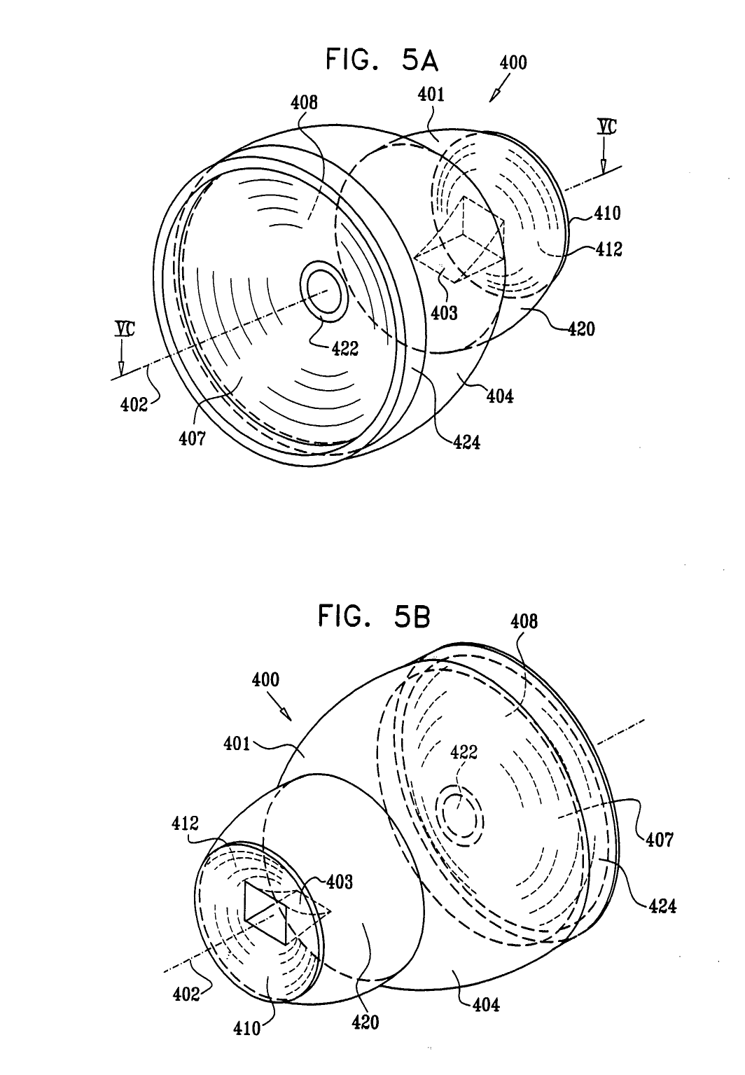

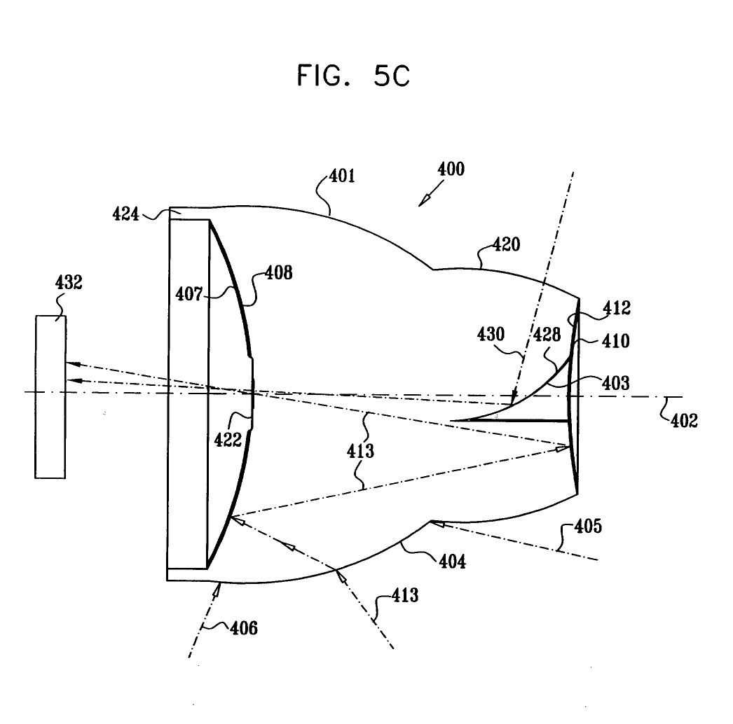

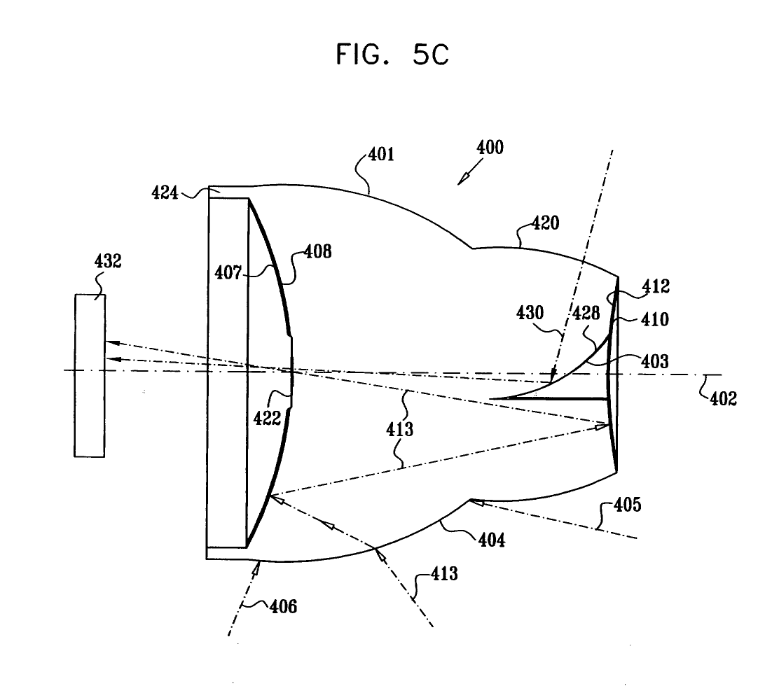

Reference is now made to FIGS. 5A, 5B and 5C, which are, respectively, simplified rearward facing and forward facing pictorial illustrations and a sectional illustration of a circumferential field of view lens constructed and operative in accordance with another preferred embodiment of the present invention. As seen in FIGS. 5A-5C, there is provided a lens 400 including a lens body 401, preferably formed of plastic, glass or any other suitable material which is transparent to radiation at a wavelength range of interest, which is symmetric about an axis of rotation 402 and includes an asymmetric surface 403.

Preferably the lens 400 includes a curved circumferential surface 404, having optical power, which receives light from a 360 degree field of view about axis 402 limited by rays 405 and 406, seen with particular clarity in FIG. 5C. Surface 404 refracts the light, as shown, onto an adjacent, preferably convex, annular reflective coating 407 formed onto a correspondingly shaped surface 408 of lens body 401. The light is reflected from convex reflective coating 407 onto an oppositely facing, preferably convex, reflective coating 410 formed onto a correspondingly shaped surface 412 of lens body 401, as shown by ray 413, which is seen with particular clarity in FIG. 5C.

It is a particular feature of the present invention that surface 412 and reflective coating 410 are substantially spaced along axis 402 from annular reflective coating 407 formed on surface 408, and thus from curved circumferential surface 404. In the illustrated embodiment, this spacing, which enhances the axial field of view of the lens 400 defined by rays 405 and 406, is provided by configuring the lens body 401 to define an intermediate circumferential surface 420, which is preferably curved, intermediate curved circumferential surface 404 and surface 412. Intermediate circumferential surface 420 typically has a different curvature than the curvature of surface 404.

Light reflected from convex reflective coating 410 preferably passes out of the lens 400 through a central portion 422 of surface 408 which is transparent to radiation at a wavelength range of interest and which is not coated by reflective coating 407.

Optionally, a rear base portion 424 may be provided around surface 408, to enable mounting of the lens onto additional elements of an optical system such as additional lenses or other suitable mechanical elements, as described hereinabove with reference to FIGS. 2 and 3. Rear base portion 424 may be integrally formed with the remainder of lens 400 or may be mounted onto the lens 400 by any suitable means. Alternatively or additionally, a forward base portion (not shown) may be provided around surface 412 for a similar purpose.

It is appreciated that in certain cases, depending on the materials used for forming the lens body 401, total internal reflection of certain light rays may occur, thus obviating the need for some or all of the reflective coatings.

The embodiment of FIGS. 5A-5C is particularly characterized in that surface 403 of lens body 401 comprises a generally planar, but preferably somewhat convex surface. Surface 403 is preferably provided with a reflective coating 428 which is operative to reflect incoming light from a given azimuthal and elevational region and to direct it through the center of central portion 422 of surface 408, as seen by ray 430. The preferred convexity of surface 403 provides magnification of the image of the given azimuthal and elevational region so as to provide an image configuration on an image plane of the general type designated by reference numeral 432.

It is appreciated that in the embodiment of FIGS. 5A-5C the intermediate circumferential surface 420 is operative to collect light. Light collected by intermediate circumferential surface 420, such as ray 430, is refracted by the intermediate circumferential surface 420 and is directed to surface 403. Intermediate circumferential surface 420 may optionally be formed to provide additional focusing of the ray 430, or to refract the collected rays, thus changing the field of view of surface 403 of lens 400.

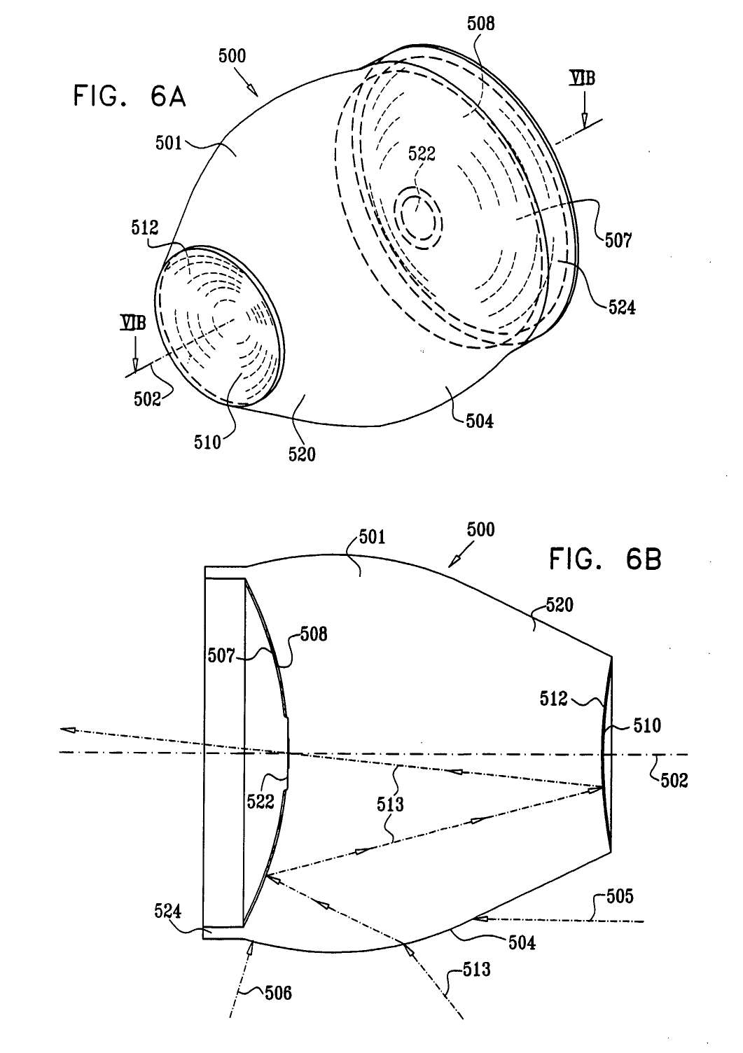

Reference is now made to FIGS. 6A and 6B, which are, respectively, a simplified pictorial illustration and a sectional illustration of a circumferential field of view lens constructed and operative in accordance with yet another preferred embodiment of the present invention. As seen in FIGS. 6A and 6B, similarly to the embodiment of FIG. 1, there is provided a lens 500 including a lens body 501, preferably formed of plastic, glass or any other suitable material which is transparent to radiation at a wavelength range of interest, which is symmetric about an axis of rotation 502.

Preferably the lens 500 includes a curved circumferential surface 504, having optical power, which receives light from a 360 degree field of view about axis 502 limited by rays 505 and 506, seen with particular clarity in FIG. 6B. Surface 504 refracts the light, as shown, onto an adjacent, preferably convex, annular reflective coating 507 formed onto a correspondingly shaped surface 508 of lens body 501. The light is reflected from convex reflective coating 507 onto an oppositely facing, preferably convex, reflective coating 510 formed onto a correspondingly shaped surface 512 of lens body 501, as shown by ray 513, which is seen with particular clarity in FIG. 6B.

It is a particular feature of the present invention that surface 512 and reflective coating 510 are substantially spaced along axis 502 from annular reflective coating 507 formed on surface 508, and thus from curved circumferential surface 504. In the illustrated embodiment, this spacing, which enhances the axial field of view of the lens 500 defined by rays 505 and 506, is provided by configuring the lens body 501 to define an intermediate circumferential surface 520, which smoothly joins curved circumferential surface 504 at the location of ray 505 and extends to surface 512. Intermediate circumferential surface 520 typically has a different curvature the curvature of surface 504, and need not collect light from the field of view of interest.

Light reflected from convex reflective coating 510 preferably passes out of the lens 500 through a central portion 522 of surface 508 which is transparent to radiation at a wavelength range of interest and which is not coated by reflective coating 507, and is focused by the optical power of the central portion 522 onto an image plane.

Optionally, a rear base portion 524 may be provided around surface 508, to enable mounting of the lens 500 onto additional elements of an optical system such as additional lenses or other suitable mechanical elements, as is described hereinabove with reference to FIGS. 2 and 3. Rear base portion 524 may be integrally formed with the remainder of lens 500 or may be mounted onto the lens 500 by any suitable means. Alternatively or additionally, a forward base portion (not shown) may be provided around surface 512 for a similar purpose.

It is appreciated that in certain cases, depending on the materials used for forming the lens body 501, total internal reflection of certain light rays may occur, thus obviating the need for some or all of the reflective coatings.

It is appreciated that the lenses and optical systems described hereinabove with reference to FIGS. 1A-6B are equally applicable for light traveling in both opposite directions, i.e. receiving light from a scene and directing it to an image plane, as specifically described hereinabove, as well as illuminating a field of view from a source of light located at the image plane.

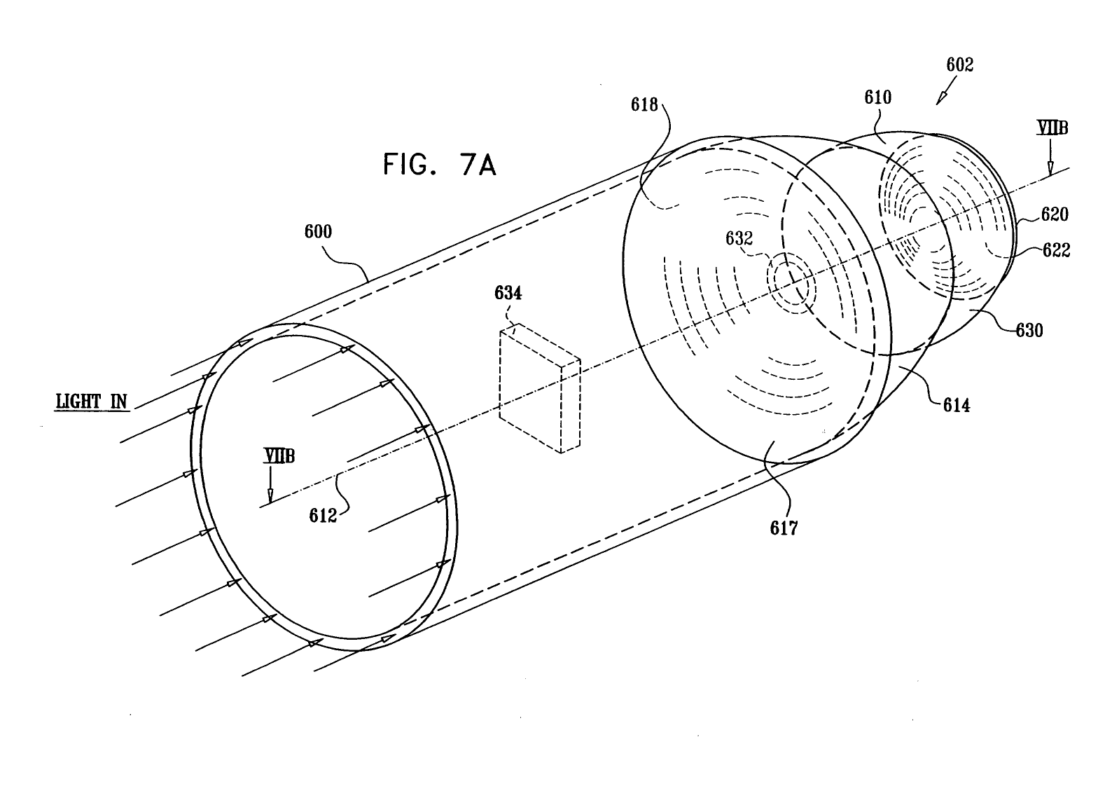

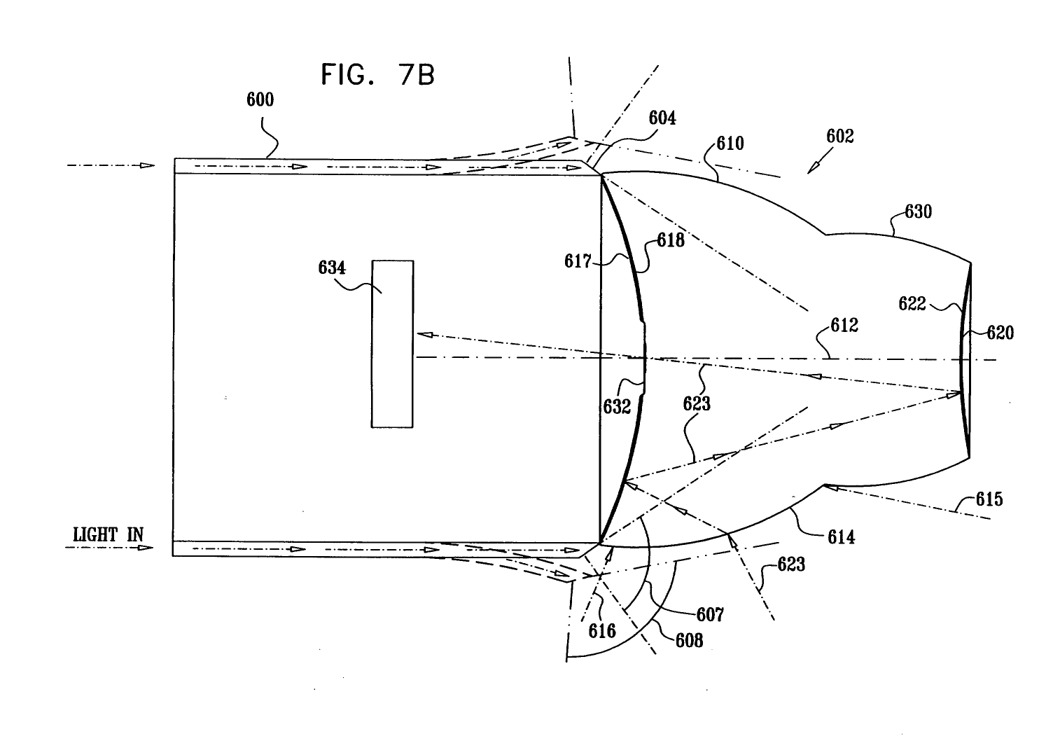

Reference is now made to FIGS. 7A and 7B, which are, respectively, a simplified pictorial illustration and a sectional illustration of an optical system constructed and operative in accordance with another preferred embodiment of the present invention. In the embodiment of FIGS. 7A and 7B, at least one light pipe 600, which may be hollow or may alternatively include optical fibers, is arranged to surround a rear surface of a lens 602 which is similar to lens 100 shown in FIGS. 1A-1C, and to have an inclined prism-like edge surface 604 located at a periphery of lens 602.

The light pipe 600 directs light from one or more light sources (not shown), which are preferably located at a rear end of light pipe 600. Light directed from the light sources is refracted by prism-like edge surface 604 of light pipe 600, and is thus scattered to illuminate at least part of the field of view of lens 602, as indicated by light rays 607 seen in FIG. 7B.

In a second operative orientation of the embodiment of FIGS. 7A and 7B, shown in FIG. 7B by dashed lines, a forward portion of light pipe 600 can be directed somewhat outwardly. In this orientation, the light scattered by prism-like edge surface 604 illuminates a different field of view of lens 602, as indicated by light rays 608 seen in FIG. 7B.

In the illustrated embodiment, lens 602 comprises a lens body 610, preferably formed of plastic, glass or any other suitable material which is transparent to radiation at a wavelength range of interest, which is symmetric about an axis of rotation 612.

Preferably the lens 602 includes a curved circumferential surface 614, having optical power, which receives light from a 360-degree field of view about axis 612 limited by rays 615 and 616, which are seen with particular clarity in FIG. 7B. Surface 614 refracts the light, as shown, onto an adjacent, preferably convex, annular reflective coating 617 formed onto a correspondingly shaped surface 618 of lens body 610. The light is reflected from convex reflective coating 617 onto an oppositely facing, preferably convex, reflective coating 620 formed onto a correspondingly shaped surface 622 of lens body 610, as shown by ray 623, which is seen with particular clarity in FIG. 7B.

It is a particular feature of the present invention that surface 622 and reflective coating 620 are substantially spaced along axis 612 from annular reflective coating 617 formed on surface 618, and thus from curved circumferential surface 614. In the illustrated embodiment, this spacing, which enhances the axial field of view of the lens 602 defined by rays 615 and 616, is provided by configuring the lens body 610 to define an intermediate circumferential surface 630, which is preferably curved, intermediate curved circumferential surface 614 and surface 622. Intermediate circumferential surface 630 typically has a different curvature than the curvature of surface 614.

Light reflected from convex reflective coating 620 preferably passes out of the lens 602 through a central portion 632 of surface 618 which is transparent to radiation at a wavelength range of interest and which is not coated by reflective coating 617. The light leaving the lens body 610 via central portion 632 is preferably directed onto an imaging sensor 634, such as a CCD array or any other suitable imaging sensor, which is disposed rearwardly of lens 602.

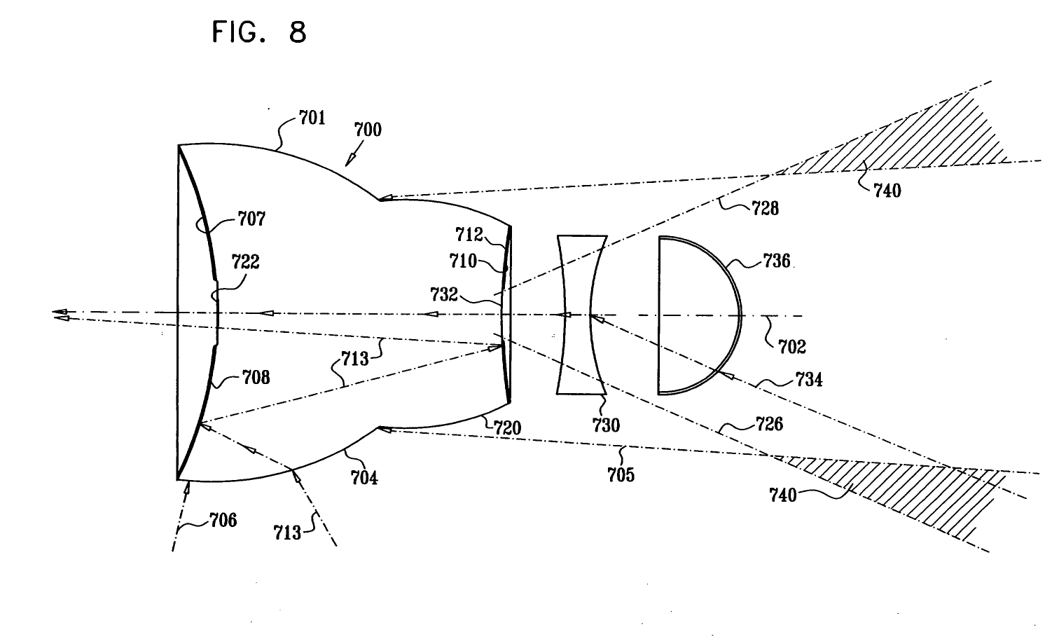

Reference is now made to FIG. 8, which is a simplified illustration of an optical system constructed and operative in accordance with still another preferred embodiment of the present invention. As seen in FIG. 8, there is provided a lens 700 including a lens body 701, preferably formed of glass or any other suitable material which is transparent to radiation at a wavelength range of interest, which is symmetric about an axis of rotation 702.

Preferably the lens 700 includes a curved circumferential surface 704, having optical power, which receives light from a 360-degree field of view about axis 702. Lens 700 preferably provides a circumferential field of view of at least approximately 90 degrees, as indicated by rays 705 and 706. Surface 704 refracts the light, as shown, onto an adjacent, preferably convex, annular reflective coating 707 formed onto a correspondingly shaped surface 708 of lens body 701. The light is reflected from convex reflective coating 707 onto an oppositely facing, preferably convex, reflective coating 710 formed onto a correspondingly shaped surface 712 of lens body 701, as shown by ray 713.

It is a particular feature of the present invention that surface 712 and reflective coating 710 are substantially spaced along axis 702 from annular reflective coating 707 formed on surface 708, and thus from curved circumferential surface 704. In the illustrated embodiment, this spacing, which enhances the axial field of view of the lens 700 defined by rays 705 and 706, is provided by configuring the lens body 701 to define an intermediate circumferential surface 720, which is preferably curved, intermediate curved circumferential surface 704 and surface 712. Intermediate circumferential surface 720 typically has a different curvature than the curvature of surface 704, and need not collect light from the field of view of interest.

Light reflected from convex reflective coating 710 preferably passes out of the lens 700 through a central portion 722 of surface 708 which is transparent to radiation at a wavelength range of interest and which is not coated by reflective coating 707.

Lens 700 may optionally be formed with a rear base portion which may be provided around surface 708, and which may enable mounting of lens 700 onto additional elements of an optical system or other suitable mechanical elements. Alternatively or additionally, a forward base portion (not shown) may be provided around surface 712 for a similar purpose.

Light from a forward field of view, limited by rays 726 and 728, preferably is refracted by a lens 730 through a central portion 732 of surface 712, interiorly of annular reflective coating 710, through the lens body 701 and out through central portion 722 of surface 708, interiorly of annular reflective coating 707, as shown by ray 734.

Lens 730 is optionally and preferably protected by a forward facing generally hemi-spherical shield 736 which is transparent to radiation at a wavelength range of interest and which ensures that the lens 730 will not be damaged, but does not corrupt the optical path of rays in the forward field of view. Alternatively, shield 736 may be obviated, leaving lens 730 exposed. Typically, lens 730 and shield 736 are mounted onto lens 700 at forward base thereof.

It is appreciated that in the illustrated embodiment, the forward field of view limited by rays 726 and 728 at least partially overlaps the circumferential field of view limited by rays 705 and 706, thus providing stereoscopic viewing of objects lying in overlapped portions 740 of the fields of view.

It is appreciated that a wavelength range of interest may include the wavelength range of visible wavelengths, the wavelength range of infrared wavelengths, or any other wavelength range.

It will be appreciated by persons skilled in the art that the present invention is not limited by what has been particularly shown and described hereinabove. Rather the scope of the present invention includes combinations and subcombinations of various features described hereinabove as well as modifications thereof which would occur to a person skilled in the art upon reading the foregoing description, and which are not in the prior art.

1. A lens having an axis of symmetry, comprising:
a transparent circumferential surface, circumferentially extending about said axis of symmetry, said transparent surface having optical power in planes which include said axis of symmetry;
a first reflective surface, symmetric with respect to said axis of symmetry and being operative to reflect light passing through said transparent surface; and
a second reflective surface, symmetric with respect to said axis of symmetry and axially spaced from said transparent surface and being operative to reflect light reflected by said first reflective surface.

2. A lens according to claim 1, and wherein said lens is formed of at least one of glass and plastic.

3. A lens according to claim 1, and wherein said transparent circumferential surface receives light from a 360-degree field of view about said axis of symmetry.

4. A lens according to claim 1 and wherein said first transparent circumferential surface is transparent to radiation at a specific range of wavelengths.

5. A lens according to claim 1, and wherein said transparent circumferential surface is operative to refract light onto said first reflective surface.

6. A lens according to claim 1 and also comprising an additional circumferential surface disposed between said transparent circumferential surface and said second reflective surface.

7. A lens according to claim 6, and wherein said transparent circumferential surface has a first curvature and said additional circumferential surface has a second curvature, said second curvature being generally different than said first curvature.

8. A lens according to claim 1, and wherein said additional circumferential surface is operative to enhance an axial field of view of said lens.

9. A lens according to claim 1, and wherein said additional circumferential surface smoothly joins said transparent circumferential surface.

10. A lens according to claim 1 and wherein at least one of said first and second reflective surfaces is a convex reflective surface.

11. A lens according to claim 1 and wherein each of said first and second reflective surfaces is a convex reflective surface.

12. A lens according to claim 1 and wherein said second reflective surface directs light generally along said axis of symmetry.

13. A lens according to claim 1 and wherein at least one of said first and second reflective surfaces is annular.

14. A lens according to claim 1 and wherein each of said first and second reflective surfaces is annular.

15. A lens according to claim 3 and wherein said second reflective surface also comprises a curved portion which has a transparent surface and which is symmetric with respect to said axis of symmetry, operative to refract rays from a field of view which is at least partially different than said 360-degree field of view.

16. A lens according to claim 15, and wherein said curved portion has a curvature which is different than a curvature of said second reflective surface.

17. A lens according to claim 15 and wherein said transparent surface of said curved portion is transparent to radiation at a specific range of wavelengths.

18. A lens according to claim 1 and wherein said first reflective surface also comprises a central area which has a transparent surface and which is symmetric with respect to said axis of symmetry.

19. A lens according to claim 18, and wherein said central area has a curvature which is different than a curvature of said first reflective surface.

20. A lens according to claim 18 and wherein said transparent surface of said central area is transparent to radiation at a specific range of wavelengths.

21. A lens according to claim 4 and wherein said specific range of wavelengths includes visible wavelengths.

22. A lens according to claim 4 and wherein said specific range of wavelengths includes infrared wavelengths.

23. A lens according to claim 1 and also comprising at least one additional lens arranged to direct light axially through said lens.

24. A lens according to claim 23 and also comprising a shield element operative to protect said at least one additional lens.

25. A lens according to claim 23 and wherein a field of view of said at least one additional lens at least partially overlaps a field of view of said lens, providing stereoscopic viewing of at least one object lying in the overlapped portions of said field of view of said at least one additional lens and said field of view of said lens.

26. A lens according to claim 1 and also comprising at least one aberration correcting lens arranged to correct aberrations of light passing through said lens.

27. A lens according to claim 1 and also including at least one of a first base portion and a second base portion.

28. A lens according to claim 27, and wherein said first base portion is disposed about said first reflective surface.

29. A lens according to claim 27, and wherein said second base portion is disposed about said second reflective surface.

30. A lens according to claim 27, and wherein at least one of said first base portion and said second base portion is integrally formed with said lens.

31. A lens according to claim 27, and wherein at least one of said first base portion and said second base portion is mounted onto said lens.

32. A lens according to claim 27, and wherein at least one of said first base portion and said second base portion is operative to mount said lens onto additional optical elements forming an optical system.

33. A lens according to claim 27, and wherein at least one of said first base portion and said second base portion is operative to mount said lens onto at least one mechanical element.

34. A lens according to claim 1 and wherein light passing through said lens is directed onto an imaging element.

35. A lens according to claim 34 and wherein said imaging element comprises a CCD array.

36. A lens according to claim 1 and also comprising a non-axially symmetric reflecting surface having optical power for focusing light from a region limited in azimuth and elevation through said lens.

37. A lens according to claim 36, and wherein said non-axially symmetric reflecting surface comprises a convex surface.

38. A lens according to claim 36, and wherein said non-axially symmetric reflecting surface comprises a generally planar surface.

39. A lens according to claim 36 and wherein said additional circumferential surface is operative to refract light received by said lens onto said non-axially symmetric reflecting surface.

40. A lens according to claim 1 and wherein said lens is operative to enable illumination of a field of view from a source of light located in an image plane.

41. A lens according to claim 1 and also comprising at least one light pipe, operative to illuminate the field of view of said lens.

42. A lens according to claim 41, and wherein said light pipe includes at least one inclined edge surface.

43. A lens according to claim 41, and wherein said light pipe includes optical fibers.

44. A lens according to claim 41, and wherein said light pipe comprises a hollow light pipe.

45. A lens according to claim 41 and wherein said light pipe is disposed about said first reflective surface.

46. A lens according to claim 42, and wherein said at least one inclined edge surface is operative to scatter light rays emitted from said light pipe.
